(19) United States
(12) Patent Application Publication
(10) Pub. No.: US 2023/0029406 A1
(43) Pub. Date: Jan. 26, 2023

(54) CHILDREN'S VEHICLE

(71) Applicant: GOODBABY CHILD PRODUCTS CO., LTD., Kunshan, Jiangsu (CN)

(72) Inventors: Hui Cai, Kunshan, Jiangsu (CN); Chunlei Wang, Kunshan, Jiangsu (CN); Chengguo Wu, Kunshan, Jiangsu (CN)

(21) Appl. No.: 17/758,419

(22) PCT Filed: Dec. 22, 2020
(86) PCT No.: PCT/CN2020/138165

§ 371 Date: Jul. 6, 2022

(30) Foreign Application Priority Data
Jan. 6, 2020 (CN) 202010009266.8

(51) Int. Cl. B62K 9/00; B62K 15/00

(52) U.S. Cl. CPC B62K 9/00; B62K 15/006

(57) ABSTRACT

Disclosed is a children's vehicle, which comprises a main vehicle frame extending in a front-rear direction, two front wheels disposed respectively on the left and right sides of the bottom-front portion of the main vehicle frame, a joystick extending upwardly inclined from front to rear, a sliding member slidingly disposed on the main vehicle frame, and a connecting bar rotatably connected between the joystick and the sliding member, wherein a lower portion of the joystick is connected to rotatably a front portion of the main vehicle frame. The children's vehicle further comprises first connecting rods, one end of each of which is rotatably connected on the main vehicle frame, and second connecting rods rotatably connected between the first connecting rods and the sliding member, the front wheels are mounted on the other ends of the first connecting rods. When the children's vehicle switches from an unfolded state to a folded state, the joystick is folded close to the main vehicle frame, the second connecting rods drive the first connecting rods to close to the main vehicle frame, and the two front wheels are folded close to the left and right sides of the main vehicle frame. When folded, the children's vehicle is very flat and compact, and the overall height and width thereof are greatly reduced.

### CROSS REFERENCE TO RELATED APPLICATION(S)

This application claims priority from Chinese Patent Application No. 202010009266.8 filed with the China Patent Office on Jan. 6, 2020, which is incorporated herein by reference in its entirety.

### TECHNICAL FIELD

The present disclosure relates to a children's vehicle, in particular to a foldable children's vehicle.

### BACKGROUND

In prior art, in order to provide children with driving pleasure, some children's vehicles are designed to simulate adult vehicles. These children's vehicles comprise a vehicle body with a seat, a direction joystick or steering wheel located in front of the seat for controlling the driving direction of the vehicle, and two groups of front wheels disposed on the left and right sides of the front part of the vehicle body and two groups of rear wheels disposed on the left and right sides of the rear part of the vehicle body. At present, this type of children's vehicles basically adopts a non-foldable structure, which results in a large space occupation and inconvenience for storage, transportation, and daily storage and carrying.

### SUMMARY

The present disclosure is aimed to overcome the deficiencies of the prior art, and provides a foldable children's vehicle.

To achieve the above purpose, a technical solution employed by the present disclosure is: A children's vehicle, has an unfolded state and a folded state, the children's vehicle comprises a main vehicle frame extending in a front-rear direction, two front wheels disposed respectively on left and right sides of a bottom-front portion of the main vehicle frame, a rear wheel disposed at a bottom-rear portion of the main vehicle frame, and a lock mechanism for locking the children's vehicle in the unfolded state, the children's vehicle further comprises a joystick extending upwardly inclined from front to rear, a sliding member slidably disposed on the main vehicle frame in the front-rear direction, and a connecting bar with one end portion rotatably connected to the joystick and the other end portion rotatably connected to the sliding member, wherein a lower portion of the joystick is rotatably connected to a front portion of the main vehicle frame,

the children's vehicle further comprises first connecting rods, one end portion of each of which is rotatably connected on the main vehicle frame, and second connecting rods rotatably connected between the first connecting rods and the sliding member, the front wheels are mounted on the other end portions of the first connecting rods, and when the children's vehicle switches from the unfolded state to the folded state, the joystick is folded close to the main vehicle frame, the second connecting rods drive the first connecting rods to close to the main vehicle frame, and the two front wheels are folded close to the left and right sides of the main vehicle frame respectively.

Preferably, the front wheels are rotatably disposed on the end portions of the first connecting rods, and when the children's vehicle is in the folded state, the front wheels are rotated relative to the first connecting rods and folded close to the sides of the main vehicle frame.

Further, the children's vehicle further comprises a steering rod that is rotatably disposed on the joystick around its own axis, and a steering drive mechanism for driving the front wheels to rotate relative to the first connecting rods to realize steering is further disposed between the steering rod and the front wheels on the left and right sides.

More further, the steering drive mechanism comprises connecting rod sets respectively disposed between the first connecting rods and the front wheels, each connecting rod set comprises a third connecting rod and a fourth connecting rod, one end portion of the third connecting rod and one end portion of the fourth connecting rod are rotatably connected to each other, the other end portion of the third connecting rod is rotatably connected to the respective first connecting rod, the other end portion of the fourth connecting rod is rotatably connected to the respective front wheel, and the steering drive mechanism further comprises a drive assembly disposed between the steering rod and the connecting rod sets on the left and right sides for driving the fourth connecting rods on the left and right sides to move.

Further, the drive assembly comprises a universal joint rotatably disposed on the main vehicle frame and fixedly connected with the steering rod, and a steering lever extending in a front-rear direction and fixedly connected to the universal joint at the front end portion thereof, and a drive connecting rod disposed at a rear end portion of the steering lever, the drive connecting rod is connected with the rear end portion of the steering lever so as to be relatively rotatable and relatively slidable along the length direction of the steering lever, and left and right end portions of the drive connecting rod are respectively rotatably connected to the third connecting rods on the left and right sides or rotatably connected to the fourth connecting rods on the left and right sides.

As a preferred implementation, the end portions of the drive connecting rod, the third connecting rods, and the fourth connecting rods are rotatably connected to each other around same center lines of rotation respectively.

As a preferred implementation, a rotating shaft is fixedly disposed in the middle of the drive connecting rod, the steering lever is provided with a sliding groove extending along its own length direction, and the rotating shaft can be relatively rotatable and relatively slidable through the sliding groove.

As a preferred implementation, the third connecting rods on the left and right sides are parallel to each other, and a parallelogram structure is formed between the main vehicle frame, the drive connecting rod, and the third connecting rods on the left and right sides.

As another preferred implementation, the third connecting rods on the left and right sides are of equal length and not parallel to each other.

As another preferred implementation, each of the front wheel comprises a front wheel frame and a front wheel body, a joint rod is disposed on the front wheel frame, and the respective fourth connecting rod and the first connecting rod are disposed parallel to each other, and the first connecting rod and the fourth connecting rod are respectively rotatably connected to two end portions of the joint rod, and a parallelogram is formed between the first connecting rod, the third connecting rod, the fourth connecting rod and the joint rod.

Preferably, the steering rod is rotatably passed through the joystick along its own axis, a steering wheel is further fixedly disposed on the upper portion of the steering rod, and when the children's vehicle is in folding, the steering rod is folded close to the main vehicle frame together with the joystick.

Preferably, the children's vehicle further comprises a seat disposed on the main vehicle frame, and when the children's vehicle is in the folded state, the steering wheel is folded close to the seat.

Preferably, the children's vehicle further comprises fifth connecting rods disposed between the main vehicle frame and the front wheels, one end portion of each of the fifth connecting rod is rotatably connected to the main vehicle frame and the other end thereof is rotatably connected to the respective front wheel, the fifth connecting rods and the first connecting rods are parallel to each other, and when the children's vehicle is folded, the fifth connecting rods and the first connecting rods are folded close to the sides of the main vehicle frame together.

Preferably, each front wheel comprises a front wheel frame, a front wheel body rotatably connected to the front wheel frame around a front wheel axle, the fourth connecting rod and the first connecting rod are rotatably connected to the front wheel frame, respectively, and when the vehicle frame is in the unfolded state or the folded state, the axis lines of the front wheel axles on the left and right sides extend parallel to or co-linear with each other.

Preferably, there are two rear wheels disposed on the left and right sides of the bottom-rear portion of the main vehicle frame, and when the children's vehicle is in the unfolded state, a distance between the two front wheels in the left-right direction is greater than a distance between the two rear wheels.

Further, when the children's vehicle is in the folded state, the distance between the two front wheels in the left-right direction is equal to the distance between the two rear wheels.

Preferably, when the children's vehicle is switched from the unfolded state to the folded state, the front wheels move backward and are folded together with the main vehicle frame, and the joystick is folded between the two front wheels.

Due to the use of the above technical solutions, the present disclosure has the following advantages over the prior art: In the children's vehicle of the present disclosure, when the joystick is pressed down to rotate and get folded relative to the main vehicle frame, the second connecting rods can drive the first connecting rods to rotate relative to the main vehicle frame, so that the front wheels on the left and right sides are folded close to the left and right sides of the main vehicle frame. The folded children's vehicle is very flat and compact, and the overall height and width of the folded children's vehicle are greatly reduced, which greatly reduces the packaging size, and is also conducive to daily storage and carrying.

### BRIEF DESCRIPTION OF THE DRAWINGS

FIG. 1 is a first stereo view of the children's vehicle according to Embodiment 1 of the present disclosure in the unfolded state;

FIG. 2 is a second stereo view of the children's vehicle according to Embodiment 1 of the present disclosure in the unfolded state (after removing a front shell);

FIG. 3 is a side view of the children's vehicle according to Embodiment 1 of the present disclosure in the unfolded state;

FIG. 4 is a bottom view of the children's vehicle according to Embodiment 1 of the present disclosure in the unfolded state;

FIG. 5 is a top view of the children's vehicle according to Embodiment 1 of the present disclosure in the unfolded state;

FIG. 6 is a top view of the children's vehicle according to Embodiment 1 of the present disclosure when the front wheels are turned to the right;

FIG. 7 is a bottom view of the children's vehicle according to Embodiment 1 of the present disclosure when the front wheels are turned to the right;

FIG. 8 is a stereo view of the children's vehicle according to Embodiment 1 of the present disclosure during the folding process;

FIG. 9 is a side view of the children's vehicle according to Embodiment 1 of the present disclosure during the folding process;

FIG. 10 is a bottom view of the children's vehicle according to Embodiment 1 of the present disclosure during the folding process;

FIG. 11 is a top view of the children's vehicle according to Embodiment 1 of the present disclosure during the folding process;

FIG. 12 is a stereo view of the children's vehicle according to Embodiment 1 of the present disclosure in the folded state;

FIG. 13 is a side view of the children's vehicle according to Embodiment 1 of the present disclosure in the folded state;

FIG. 14 is a bottom view of the children's vehicle according to Embodiment 1 of the present disclosure in the folded state;

FIG. 15 is a top view of the children's vehicle according to Embodiment 1 of the present disclosure in the folded state;

FIG. 16 is a top view of the children's vehicle according to Embodiment 2 of the present disclosure in the unfolded state;

FIG. 17 is a bottom view of the children's vehicle according to Embodiment 2 of the present disclosure in the unfolded state;

FIG. 18 is a top view of the children's vehicle according to Embodiment 2 of the present disclosure when it is turned to the right;

FIG. 19 is a bottom view of the children's vehicle according to Embodiment 2 of the present disclosure when it is turned to the right;

FIG. 20 is a top view of the children's vehicle according to Embodiment 2 of the present disclosure when it is turned further to the right;

FIG. 21 is a bottom view of the children's vehicle according to Embodiment 2 of the present disclosure when it is turned further to the right;

FIG. 22 is a first stereo view of the children's vehicle according to Embodiment 3 of the present disclosure in the unfolded state;

FIG. 23 is a second stereo view of the children's vehicle according to Embodiment 3 of the present disclosure in the unfolded state;

FIG. 24 is a stereo view of the children's vehicle according to Embodiment 3 of the present disclosure in the folded state;

Wherein: 1, main vehicle frame; 101, sliding rod; 102, connecting seat; 2, joystick; 3, sliding member; 31, unlocking button; 4, connecting bar; 5, steering rod; 6, steering wheel; 7, universal joint; 8, steering lever; 9, drive connecting rod; 11, first connecting rod; 12, second connecting rod; 13, third connecting rod; 14, fourth connecting rod; 15, fifth connecting rod; 10, seat; 20, front wheel; 201, front wheel frame; 202, front wheel body; 203, joint rod; 30, rear wheel; 40, motor cover; 50, front shell; 501, pedal part.

### DETAILED DESCRIPTION OF EXEMPLARY EMBODIMENTS

In the following, the technical solution of the present disclosure is further described combining with the accompanying drawings and specific embodiments.

### Embodiment 1

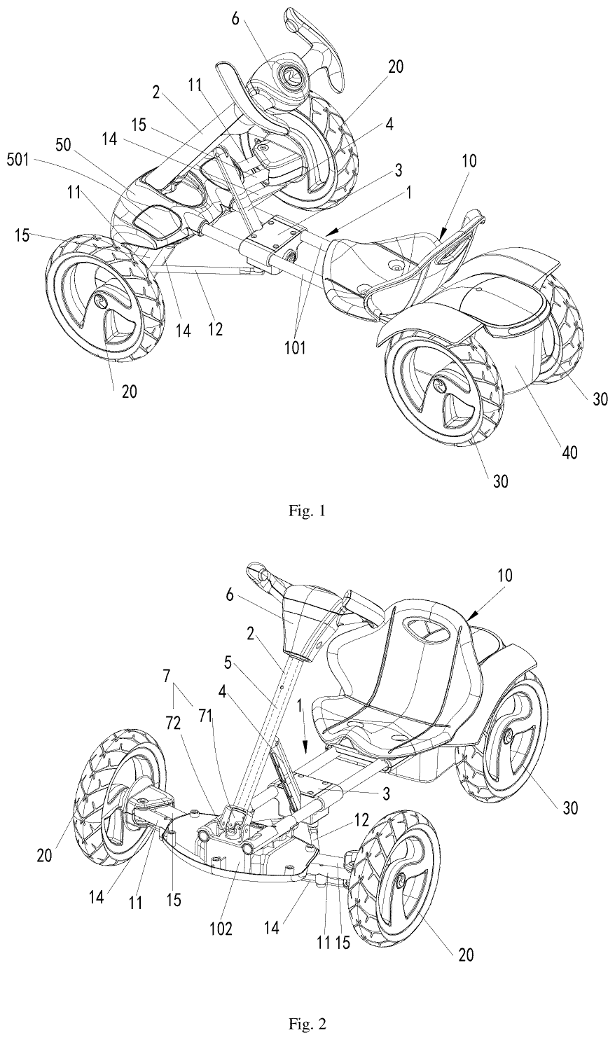

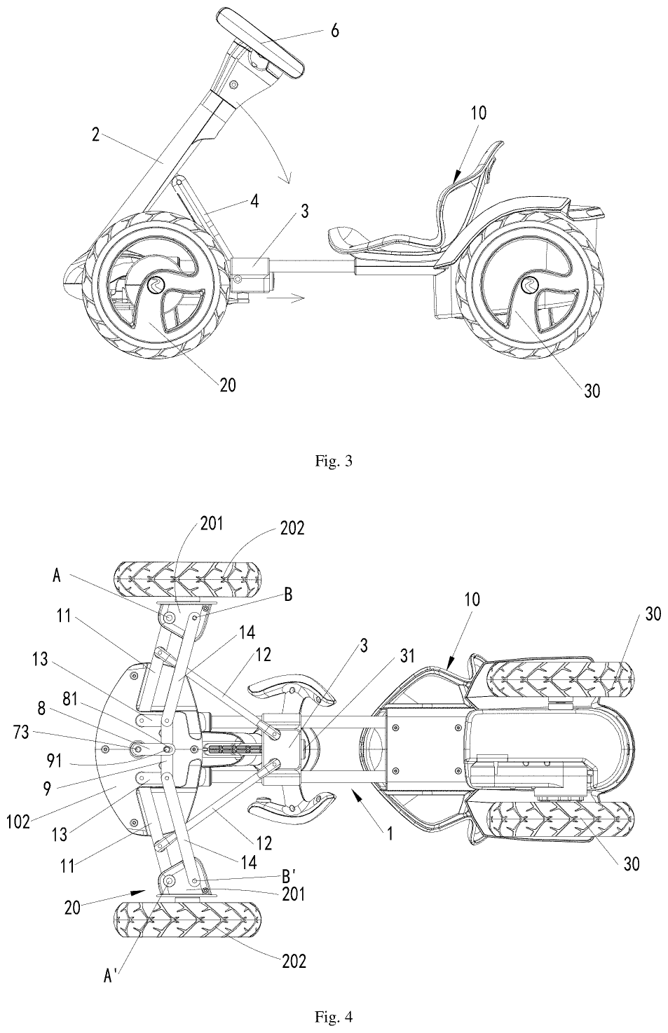

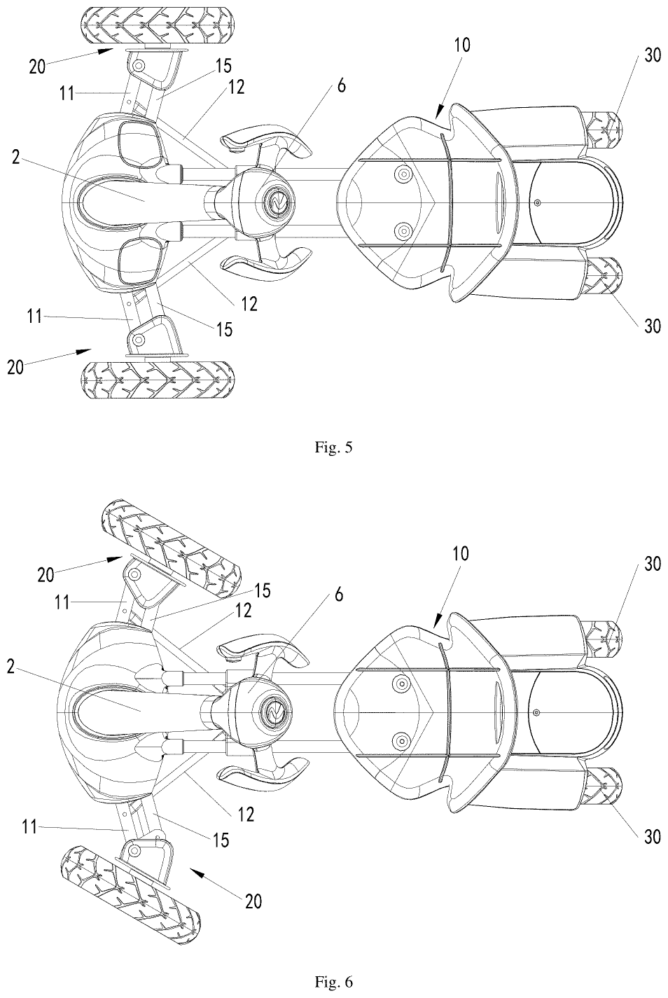

Referring to the children's vehicle shown in FIGS. 1 to 15, it has an unfolded state and a folded state. The children's vehicle comprises a main vehicle frame 1 extending in a front-rear direction, two front wheels 20 disposed respectively on left and right sides of a bottom-front portion of the main vehicle frame 1, a rear wheel 30 disposed at a bottom-rear portion of the main vehicle frame 1, a seat 10 disposed at a rear portion of the main vehicle frame 1, and a lock mechanism for locking the children's vehicle in the unfolded state.

In this embodiment, the children's vehicle further comprises a drive motor (not shown) disposed on the main vehicle frame 1, that is, the children's vehicle is a children's electric vehicle. There are also two rear wheels 30 disposed on the left and right sides of the main vehicle frame 1, and when the children's vehicle is in the unfolded state, the distance between the two front wheels 20 is greater than the distance between the two rear wheels 30. The rear portion of the main vehicle frame 1 is further provided with a motor cover 40, the motor cover 40 is located between the two rear wheels 30 and behind the seat 10, and the motor cover 40 accommodates a drive motor and a battery, wherein the drive motor is used for driving the rear wheels 30 to rotate and the battery is used to provide power to the drive motor.

The children's vehicle further comprises a joystick 2 extending upwardly inclined from front to rear, a front portion of the main vehicle frame 1 is provided with a front shell 50, two pedal parts 501 are disposed on the front shell 50, the two pedal parts 501 are respectively provided on left and right sides of the joystick 2, and when a child sits on the seat 10, the child steps on the pedal parts 501 to drive the children's electric vehicle.

The children's vehicle further comprises a sliding member 3 slidably disposed on the main vehicle frame 1 in the front-rear direction, and a connecting bar 4 with one end portion rotatably connected to the joystick 2 and the other end portion rotatably connected to the sliding member 3, wherein the lower portion of the joystick 2 is rotatably connected to the front portion of the main vehicle frame 1. Here, the main vehicle frame 1 has two sliding rods 101 extending in the front-rear direction, the sliding member 3 is slidably sleeved on the two sliding rods 101, the seat 10 is fixedly disposed on the two sliding rods 101, and the sliding member 3 is slidable in front of the seat 10 along the sliding rods 101. In some embodiments, the seat is slidably disposed on the sliding rods 101, so that the front and rear positions of the seat 10 can be adjusted according to the age or height of the child, so that the child can sit comfortably and drive conveniently when sitting on the seat 10.

The children's vehicle further comprises first connecting rods 11, one end portion of each of which is rotatably connected on the main vehicle frame 1, and second connecting rods 12 rotatably connected between the first connecting rods 11 and the sliding member 3, and the front wheels 20 are mounted on the other end portions of the first connecting rods 11. In this embodiment, one end of each second connecting rod 12 is rotatably connected with the lower wall of the sliding member 3, and the other end of each second connecting rod 12 is rotatably connected with the upper wall of the respective first connecting rod 11, and the second connecting rods 12 are located below the sliding rods 101; when the children's vehicle is switched from the unfolded state to the folded state, the joystick 2 is rotated and folded toward the main vehicle frame 1, so that the sliding member 3 slides backward along the main vehicle frame 1, and the rear end portions of the second connecting rods 12 move backward with the sliding member 3, so that the second connecting rods 12 are rotated to drive the first connecting rods 11 on the two sides to be folded toward the main vehicle frame 1, so that the front wheels 20 on the two sides are folded on the left and right sides of the main vehicle frame 1.

Referring to the figures, on the children's vehicle, the front wheels 20 are rotatably disposed on the end portions of the first connecting rods 11, and when the children's vehicle is in folding, the front wheels 20 on the left and right sides are rotated relative to the first connecting rods 11 so as to fold the front wheels 20 close on the sides of the main vehicle frame 1.

Referring to the figures, the children's vehicle further comprises a steering rod 5 that is rotatably disposed on the joystick 2 around its own axis, specifically, the steering rod 5 is rotatably passed through the joystick 2 along its own axis, a steering wheel 6 is further fixedly disposed on an upper portion of the steering rod 5 for the child sitting on the seat 10 to hold and operate, and when the children's vehicle is folded, the steering rod 5 is folded close to the main vehicle frame 1 together with the joystick 2.

A steering drive mechanism for driving the front wheels 20 to rotate relative to the first connecting rods 11 to realize steering is further disposed between the steering rod 5 and the front wheels 20 on the two sides. Referring to FIGS. 4 to 7, the steering drive mechanism comprises connecting rod sets respectively disposed between the first connecting rods 11 and the front wheels 20, and there are two connecting rod sets respectively disposed on the left and right sides of the main vehicle frame 1, each connecting rod set comprises a third connecting rod 13 and a fourth connecting rod 14, one end portion of the third connecting rod 13 are rotatably connected to one end portion of the fourth connecting rod 14, the other end portion of the third connecting rod 13 is rotatably connected to the respective first connecting rod 11, and the other end portion of the fourth connecting rod 14 is rotatably connected to the respective front wheel 20. Wherein, the front wheel 20 comprises a front wheel frame 201 and a front wheel body 202, and the front wheel body 202 is rotatably mounted on the outer side of the front wheel frame 201 around a front wheel axle (not shown). The first connection rod 11 and the fourth connection rod 14 are respectively rotatably connected to the front wheel frame 201, and are rotatably connected to the front wheel frame 201 around different rotation shafts. In this way, the first connection rod 11, the third connection rod 13, the fourth connection rod 14 and the front wheel frame 201 form a four-bar linkage mechanism. When the fourth connection rod 14 is driven to move, the front wheel frame 201 is rotated relative to the first connection rod 11, thereby realizing the steering of the front wheel 20.

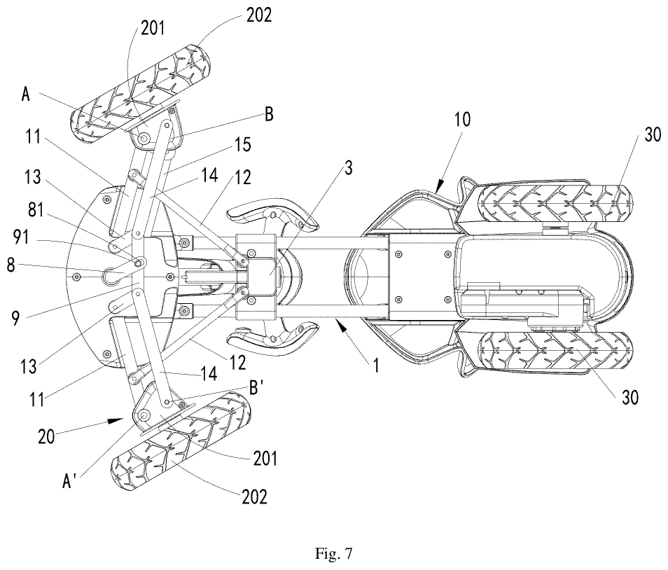

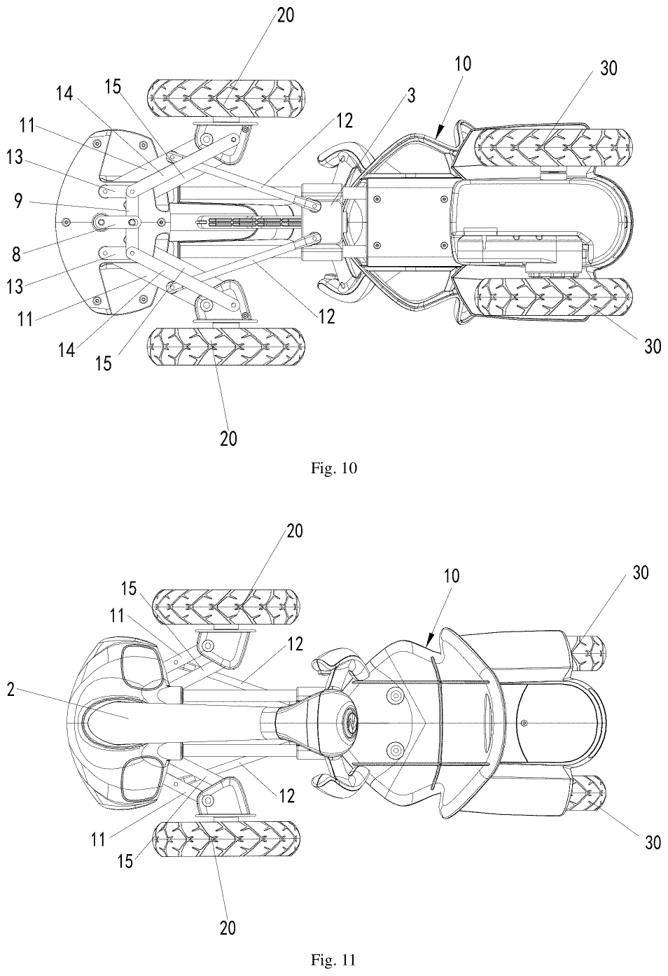

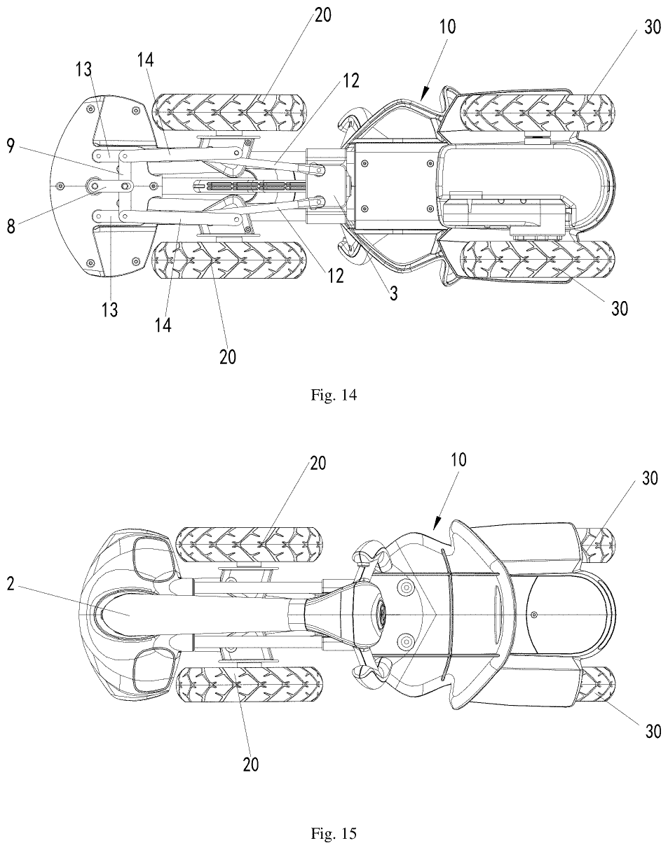

The steering drive mechanism further comprises a driving assembly disposed between the steering rod 5 and the connecting rod sets on the two sides for driving the fourth connecting rods 14 on the two sides to move. Referring to FIG. 2, FIG. 4, FIG. 7, FIG. 10 and FIG. 14, in this embodiment, the drive assembly comprises a universal joint 7 rotatably disposed on the main vehicle frame 1 and fixedly connected with the steering rod 5, and a steering lever 8 extending in the front-rear direction and fixedly connected to the universal joint 7 at the front end portion thereof, and a drive connecting rod 9 disposed at a rear end portion of the steering lever 8, the drive connecting rod 9 is connected with the rear end portion of the steering lever 8 so as to be relatively rotatable and relatively slidable along the length direction of the steering lever 8, and the two end portions of the drive connecting rod 9 are respectively rotatably connected to the third connecting rods 13 on the two sides or rotatably connected to the fourth connecting rods 14 on the two sides.

Specifically, as shown in the figures, the main vehicle frame 1 further comprises a connecting seat 102 located at the front portion of the sliding rod 101, and the lower portion of the joystick 2 is connected to the connecting seat 102. In this embodiment, the universal joint 7 is provided with a first portion 71 and a second portion 72 that rotate relative to each other, the first portion 71 is fixedly disposed at the lower portion of the steering rod 5, and the second portion 72 can pass through a fixed shaft 73 and be rotatably disposed on the connection seat 102 around the axis line of the fixed shaft 73, and the front end portion of the steering lever 8 is fixedly on the second portion 72, so that the steering lever 8 can also rotate around the axis line of the fixed shaft 73.

Referring to FIG. 4 and FIG. 7, in this embodiment, the plane where the drive connecting rod 9 is located is located below the plane where the first connecting rods 11 are located, and the plane where the drive connecting rod 9 is located is located above the plane where the steering lever 8 is located. A rotating shaft 91 is fixedly disposed on the lower surface of the middle portion of the drive connecting rod 9, the axis line of the rotating shaft 91 and the axis line of the fixed shaft 73 both extend in the up-down direction and are parallel to each other, the rear portion of the steering lever 8 is provided with a sliding groove 81 extending along its own length direction, and the rotating shaft 91 can be relatively rotatable and relatively slidable through the sliding groove 81. Two end portions of the drive connecting rod 9 in the length direction thereof are rotatably connected to the corresponding third connecting rods 13 and the corresponding fourth connecting rods 14 around a same center line of rotation, respectively. In this embodiment, the third connecting rod 13 and the fourth connecting rod 14 are located on the upper and lower sides of the driving connecting rod 9 respectively, and the third connecting rod 13, the fourth connecting rod 14, the drive connecting rod 9 and the fourth connecting rod 14 are all located below the connecting seat 102, and the connecting seat 102, the steering lever 8, the drive connecting rod 9, and the third connecting rod 13 are all accommodated in the inner cavity of a front shell 50. In this way, in the unfolded state of the children's vehicle, when the steering wheel 6 is rotated, the steering rod 5 is rotated synchronously, so that the second portion 72 of the universal joint 7 is rotated relative to the main vehicle frame 1 around the fixed shaft 73, thereby driving the steering lever 8 to rotate around the fixed shaft 73 synchronously, the sliding groove 81 at the rear portion of the steering lever 8 acts on the rotating shaft 91 to drive the drive connecting rod 9 to move, thereby causing the fourth connecting rods 14 on the two sides to move, thereby causing the front wheels 20 on the two sides to move relative to the first connecting rods 11 to achieve the steering of the front wheels 20.

In this embodiment, the third connecting rods 13 on the two sides have the same length and are parallel to each other, and a parallelogram mechanism is formed between the main vehicle frame 1 and the drive connecting rod and the third connecting rods 13 on the two sides, which causes the front wheels 30 on the two sides can be steered synchronously to the left or right, and the steering angles of the left front wheel 30 and the right front wheel 30 are the same. The specific steering steps and principles are as follows:

Referring to FIGS. 6 and 7, when turning to the right is required, the operator operates the steering wheel 6 to rotate it clockwise, and the steering rod 5 is driven to drive the steering lever 8 to rotate clockwise around the fixed shaft 73 accordingly, and under the action of the rotating shaft 91, the drive connecting rod 9 is driven to move to the left, and the fourth connecting rod 14 on the left side is driven to move outward in the left-right direction, that is, the rotation axis B moves outward, so that the front wheel body 202 and the front wheel frame 201 on the left side are rotated around a rotating shaft A relative to the first connecting rod 11, so that the front portion of the front wheel body 202 on the left side is inclined inward and the rear portion thereof is inclined outward; at the same time, the fourth connecting rod 14 on the right side is driven to move inward in the left-right direction, that is, the rotation axis B′ moves inward, so that the front wheel body 202 and the front wheel frame 201 on the right side are rotated around a rotating shaft A′ relative to the first connecting rod 11, so that the front portion of the front wheel body 202 on the right side is inclined outward and the rear portion thereof is inclined inward. In this way, the front wheel bodies 202 on both sides are turned to the right side to realize synchronous steering to the right.

When it is necessary to turn to the left, the driver operates the steering wheel 6 to rotate it counterclockwise, so that the front wheel bodies 202 on both sides are turned to the left side to realize synchronous steering to the left. The steering principle is similar to the above-mentioned principle of right steering, and will not be repeated here. Referring to the figures, the children's vehicle further comprises fifth connecting rods 15 disposed between the main vehicle frame 1 and the front wheels 20, one end portion of each of the fifth connecting rod 15 is rotatably connected to the main vehicle frame 1 and the other end portion thereof is rotatably connected to the respective front wheel 20, and the fifth connecting rod 15 and the respective first connecting rod 11 are parallel to each other. In this embodiment, the fifth connecting rods 15 and the first connecting rods 11 are located at approximately the same height, the fourth connecting rods 14 are connected to the bottoms of the front wheel frames 201, there are gaps between the fourth connecting rods 14 and the fifth connecting rods 15 in the up-down direction, and the front portions of the second connecting rods 12 pass through the gaps and are connected to the first connecting rods 11. When the second connecting rods 12 drive the first connecting rods 11 to rotate toward and fold close to the main vehicle frame 1, the fifth connecting rods 15 rotate synchronously with the first connecting rods 11, and together fold toward the sides of the main vehicle frame 1. The arrangement of the fifth connecting rods 15 causes the structure of the children's vehicle more stable in the unfolded state.

On the children's vehicle of this embodiment, the lock mechanism comprises a locking member (not shown) disposed between the sliding member 3 and the main vehicle frame 1, and when the locking member is locked, the sliding member 3 is locked relative to the main vehicle frame 1, so that the joystick 2, the main vehicle frame 1, the connecting bar 4 and the sliding member 3 are locked relative to each other, and so that the first connecting rods 11, the main vehicle frame 1, the second connecting rods 12 and the sliding member 3 are locked relative to each other, that is, the children's vehicle is locked in the unfolded state. The sliding member 3 is also provided with an unlocking button 31 for unlocking the locking member.

Referring to FIGS. 1 to 7, the children's vehicle is locked in the unfolded state, the second connecting rods 12 are supported between the first connecting rods 11 and the sliding member 3, so that the front wheels 20 on both sides are opened outward, and the distance between the two front wheels 20 in the left-right direction is greater than the distance between the two rear wheels 30. The child sitting on the seat 10 can control the vehicle by holding the steering wheel 6, and when the steering wheel 6 is turned, the steering rod 5 will drive the universal joint 7, the steering lever 8 and the drive connecting rod 9 to move to drive the fourth connecting rods 14 to move, and then drives the front wheels 20 on both sides to rotate relative to the first connecting rods 11 to realize the steering operation.

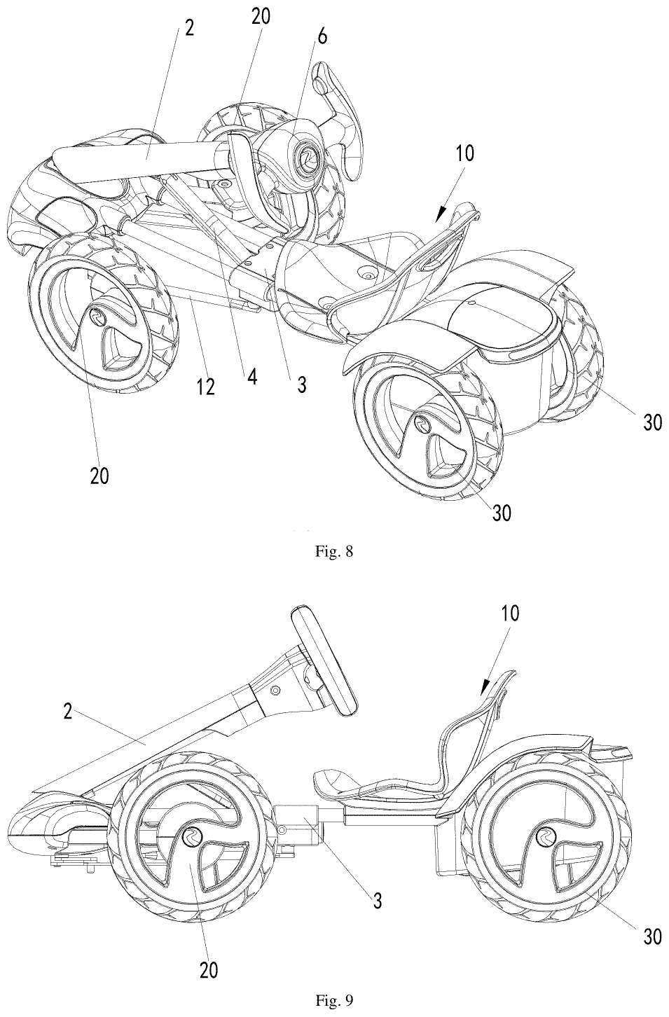

When the children's vehicle needs to be folded up, as shown in FIGS. 8 to 11, first press the unlocking button 31 to unlock the locking member, then press the joystick 2 downward to rotate toward and fold close to the main vehicle frame 1, and the sliding member 3 slides along the main vehicle frame 1 backward, driving the rear portion of the second connecting rods 12 to move backward, and the second connecting rods 12 gradually rotate toward and fold close to the main vehicle frame 1, and drive the first connecting rods 11, the fourth connecting rods 14 and the fifth connecting rods 15 to rotate together toward and fold close to the main vehicle frame 1 at the same time, and the front wheels 20 rotate relative to the first connecting rods 11 to gradually move toward the sides of the main vehicle frame 1.

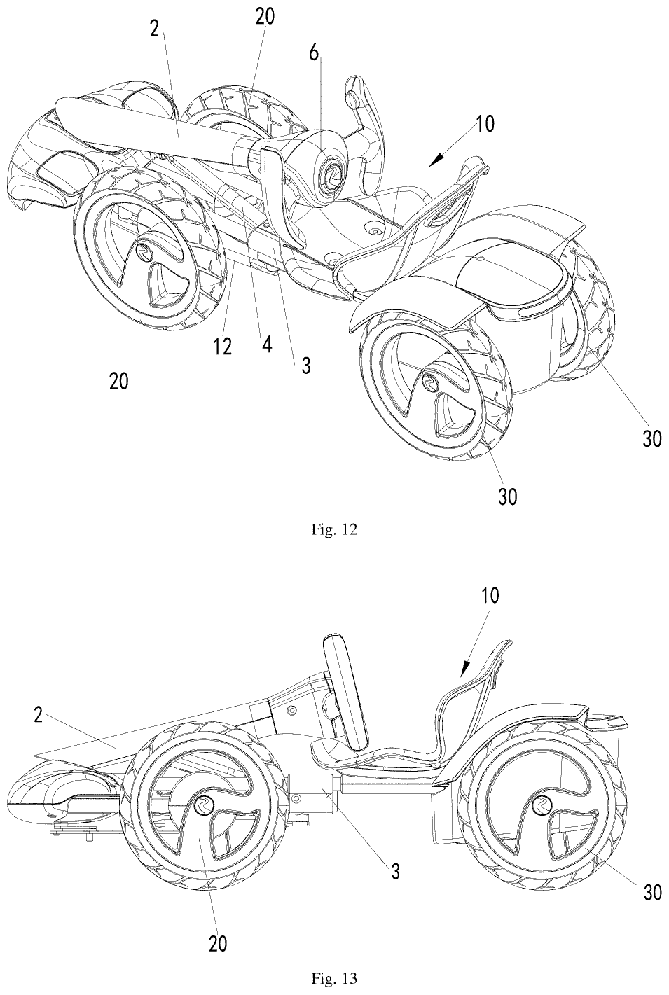

The final folded state of the children's vehicle is shown in FIGS. 12 to 15, the joystick 2 together with the steering wheel 6 are close to the top of the main vehicle frame 1, the main body of the steering wheel 6 is located just above the front of the seat 10, and is partially staggered and overlapped in height. The front wheels 20 on the two sides are close to the left and right sides of the main vehicle frame 1, and in this embodiment, in the folded state, the fourth connecting rods 14 are located directly below the first connecting rods 11, the extension direction of the front wheel axles of the two front wheels 20 is kept consistent with the extension direction of the front wheel axles when unfolded, and the distance between the two front wheels 20 in the left-right direction is the same as the distance between the two rear wheels 30. In this folded state, in the left-right direction, the distance between the two front wheels 20, the distance between the two rear wheels 30, the width of the front shell 50, the width of the seat 10 and the width of the steering wheel 6 are basically the same, so that the packaging size is reduced, the structure of the whole children's vehicle is flat and compact, and the packaging is very convenient.

When unfolding the children's vehicle, it is only necessary to pull the joystick 2 upwards, and at the same time press the main vehicle frame 1 downwards, the whole children's vehicle can be unfolded, and the unfolding operation is also very simple and convenient.

### Embodiment 2

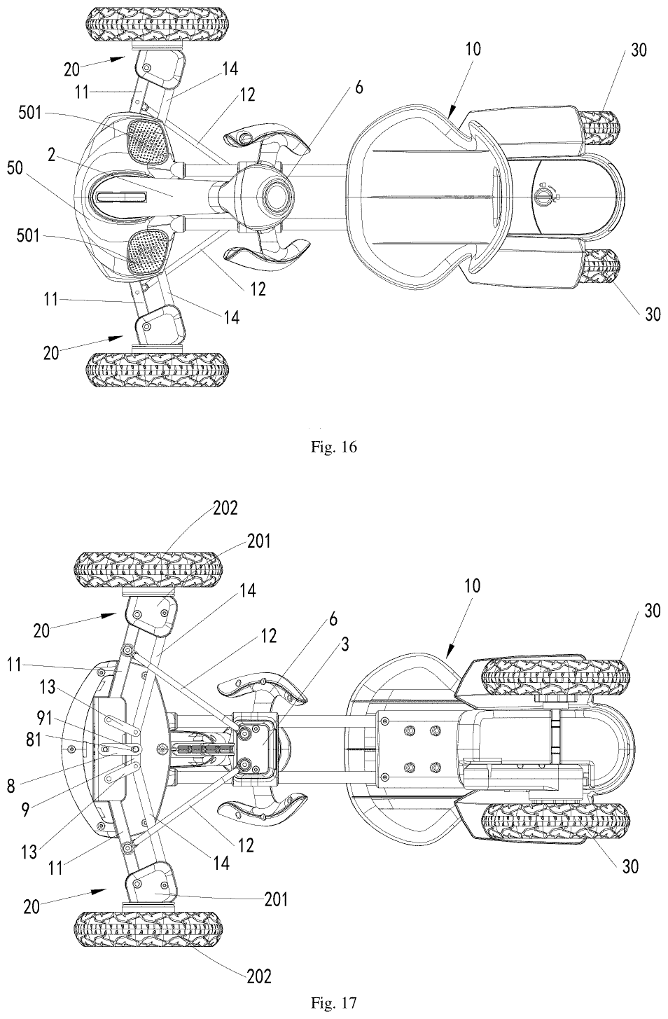

Referring to FIGS. 16 to 21, the main difference between this embodiment and the children's vehicle of Embodiment 1 is that in this embodiment, the two third connecting rods 13 on the left and right sides in the steering drive mechanism are not parallel to each other, here, the lengths of the third connecting rods 13 on the two sides are equal, and a four-connecting rod mechanism is formed between the main vehicle frame 1, the third connecting rods 13 on the two sides and the drive connecting rod 9, which causes the angle of rotation of the front wheels 20 on the two sides different when turning. The specific steering steps and principles are as follows:

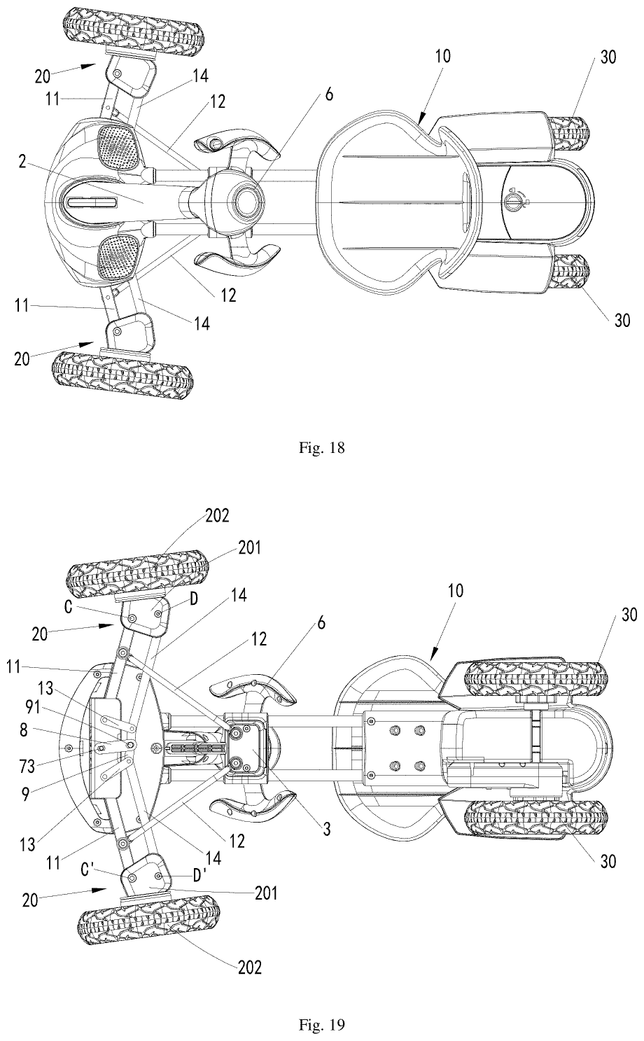

Referring to FIGS. 18 and 21, when turning to the right is required, the operator operates the steering wheel 6 to rotate it clockwise, and the steering rod 5 is driven to drive the steering lever 8 to rotate clockwise around the fixed shaft 73 accordingly, and under the action of the rotating shaft 91, the drive connecting rod 9 is driven to move to the left, and the fourth connecting rod 14 on the left side is driven to move outward in the left-right direction, that is, the rotation axis D moves outward, so that the front wheel body 202 and the front wheel frame 201 on the left side are rotated around a rotating shaft C relative to the first connecting rod 11, so that the front portion of the front wheel body 202 on the left side is inclined inward and the rear portion thereof is inclined outward; at the same time, the fourth connecting rod 14 on the right side is driven to move inward in the left-right direction, that is, the rotation axis D′ moves inward, so that the front wheel body 202 and the front wheel frame 201 on the right side are rotated around a rotating shaft C′ relative to the first connecting rod 11, so that the front portion of the front wheel body 202 on the right side is inclined outward and the rear portion thereof is inclined inward.

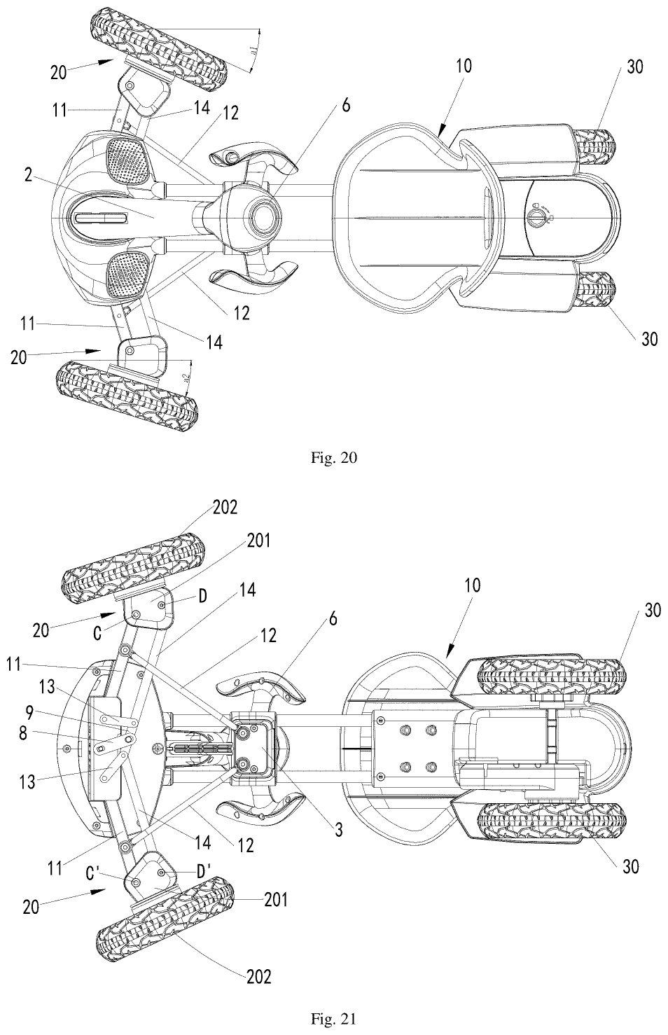

During the above steering process, due to the action of the third connecting rods 13 on the two sides, the drive connecting rod 9 rotates around the rotating shaft 91 at the same time under the driving of the steering lever 8, so that the displacements of the rotating shaft D and the rotating shaft D′ in the left-right direction are different, as shown in FIG. 20 and FIG. 21, the steering angle a1 of the right front wheel 20 is greater than the steering angle a2 of the left front wheel 20. That is, on the steered travel path, the steering angle of the front wheel 20 located on the inner side is larger, and the steering angle of the front wheel 20 located on the outer side is smaller. This results in a certain difference in the steering angles of the front wheels 20 on the two sides, so that the children's vehicle can drift.

When it is necessary to turn to the left, the driver operates the steering wheel 6 to rotate it counterclockwise, so that the front wheel bodies 202 on both sides are turned to the left side to realize synchronous steering to the left. The steering principle is similar to the above-mentioned principle of right steering, and will not be repeated here.

Another difference between this embodiment and Embodiment 1 is that the fifth connecting rods 15 are omitted. In the case where the fifth connecting rods 15 are omitted, the basic performance of the children's vehicle is basically the same as that of Embodiment 1.

### Embodiment 3

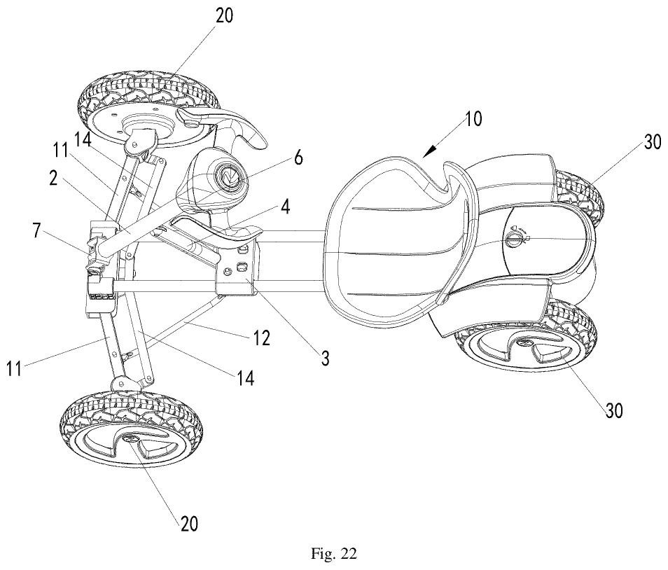

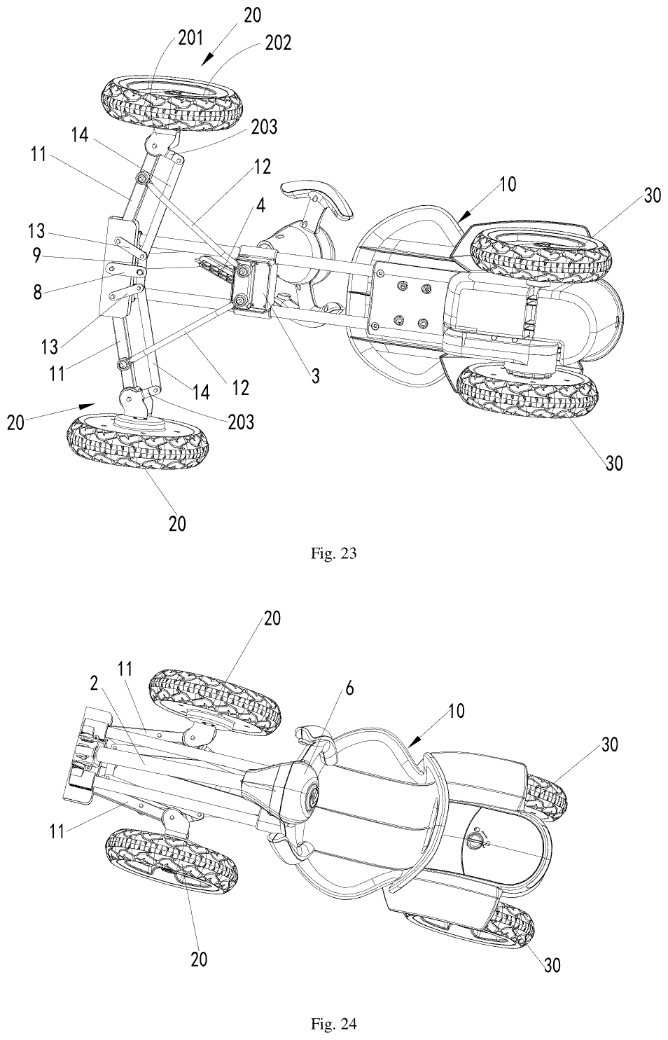

Referring to FIG. 22 to FIG. 24, the main difference between the children's vehicle of this embodiment and the children's vehicle of Embodiment 2 is that each of the front wheel frame 201 has a joint rod 203, the fourth connecting rod 14 and the first connecting rod 11 are disposed parallel to each other, and the outer end portion of the first connecting rod 11 and the fourth connecting rod 14 are respectively rotatably connected to the two end portions of the joint rod 203, and a parallelogram is respectively formed between the first connecting rod 11, the third connecting rod 13, the fourth connecting rod 14 and the joint rod 203 on each side. The folding principle of the children's vehicle and the steering principles of the front wheels are the same as those of the children's vehicle in Embodiment 2, and will not be repeated here.

The embodiments described above are only for illustrating the technical concepts and features of the present disclosure, and are intended to make those skilled in the art being able to understand the present disclosure and thereby implement it, and should not be concluded to limit the protective scope of this disclosure. Any equivalent variations or modifications according to the essence of the present disclosure should be covered by the protective scope of the present disclosure.

1-3. (canceled)

4. A children's vehicle, having an unfolded state and a folded state, the children's vehicle comprises a main vehicle frame extending in a front-rear direction, two front wheels disposed respectively on left and right sides of a bottom-front portion of the main vehicle frame, a rear wheel disposed at a bottom-rear portion of the main vehicle frame, and a lock mechanism for locking the children's vehicle in the unfolded state, wherein the children's vehicle further comprises a joystick extending upwardly inclined from front to rear, a sliding member slidably disposed on the main vehicle frame in the front-rear direction, and a connecting bar with one end portion rotatably connected to the joystick and the other end portion rotatably connected to the sliding member, wherein a lower portion of the joystick is rotatably connected to a front portion of the main vehicle frame,
the children's vehicle further comprises first connecting rods, one end portion of each of which is rotatably connected on the main vehicle frame, and second connecting rods rotatably connected between the first connecting rods and the sliding member, the front wheels are mounted on the other end portions of the first connecting rods, and when the children's vehicle switches from the unfolded state to the folded state, the joystick is folded close to the main vehicle frame, the second connecting rods drive the first connecting rods to close to the main vehicle frame, and the two front wheels are folded close to the left and right sides of the main vehicle frame respectively.

5. The children's vehicle according to claim 4, wherein the front wheels are rotatably disposed on the end portions of the first connecting rods, and when the children's vehicle is in the folded state, the front wheels are rotated relative to the first connecting rods and folded close to the sides of the main vehicle frame.

6. The children's vehicle according to claim 5, wherein the children's vehicle further comprises a steering rod that is rotatably disposed on the joystick around its own axis, and a steering drive mechanism for driving the front wheels to rotate relative to the first connecting rods to realize steering is further disposed between the steering rod and the front wheels on the left and right sides.

7. The children's vehicle according to claim 6, wherein the steering drive mechanism comprises connecting rod sets respectively disposed between the first connecting rods and the front wheels, each connecting rod set comprises a third connecting rod and a fourth connecting rod, one end portion of the third connecting rod and one end portion of the fourth connecting rod are rotatably connected to each other, the other end portion of the third connecting rod is rotatably connected to the respective first connecting rod, the other end portion of the fourth connecting rod is rotatably connected to the respective front wheel, and the steering drive mechanism further comprises a drive assembly disposed between the steering rod and the connecting rod sets on the left and right sides for driving the fourth connecting rods on the left and right sides to move.

8. The children's vehicle according to claim 7, wherein the drive assembly comprises a universal joint rotatably disposed on the main vehicle frame and fixedly connected with the steering rod, and a steering lever extending in the front-rear direction and fixedly connected to the universal joint at a front end portion thereof, and a drive connecting rod disposed at a rear end portion of the steering lever, the drive connecting rod is connected with the rear end portion of the steering lever so as to be relatively rotatable and relatively slidable along the length direction of the steering lever, and left and right end portions of the drive connecting rod are respectively rotatably connected to the third connecting rods on the left and right sides or rotatably connected to the fourth connecting rods on the left and right sides.

9. The children's vehicle according to claim 8, wherein the end portions of the drive connecting rod, the third connecting rods, and the fourth connecting rods are rotatably connected to each other around same center lines of rotation respectively.

10. The children's vehicle according to claim 8, wherein a rotating shaft is fixedly disposed in the middle of the drive connecting rod, the steering lever is provided with a sliding groove extending along its own length direction, and the rotating shaft can be relatively rotatable and relatively slidable through the sliding groove.

11. The children's vehicle according to claim 8, wherein the third connecting rods on the left and right sides are parallel to each other, and a parallelogram structure is formed between the main vehicle frame, the drive connecting rod, and the third connecting rods on the left and right sides.

12. The children's vehicle according to claim 8, wherein the third connecting rods on the left and right sides are of equal length and not parallel to each other.

13. The children's vehicle according to claim 7, wherein each front wheel comprises a front wheel frame and a front wheel body, a joint rod is disposed on the front wheel frame, and the fourth connecting rod and the first connecting rod are disposed parallel to each other, and the first connecting rod and the fourth connecting rod are respectively rotatably connected to two end portions of the joint rod, and on the left and right sides of the children's vehicle, a parallelogram is formed between the first connecting rod, the third connecting rod, the fourth connecting rod and the joint rod.

14. The children's vehicle according to claim 6, wherein the steering rod is rotatably passed through the joystick along its own axis, a steering wheel is further fixedly disposed on the upper portion of the steering rod, and when the children's vehicle is folded, the steering rod is folded close to the main vehicle frame together with the joystick.

15. The children's vehicle according to claim 14, wherein the children's vehicle further comprises a seat disposed on the main vehicle frame, and when the children's vehicle is in the folded state, the steering wheel is folded close to the seat.

16. The children's vehicle according to claim 7, wherein each front wheel comprises a front wheel frame, a front wheel body rotatably connected to the front wheel frame around a front wheel axle, the fourth connecting rod and the first connecting rod are rotatably connected to the front wheel frame, respectively, and when the vehicle frame is in the unfolded state or the folded state, the axis lines of the front wheel axles on the left and right sides extend parallel to or co-linear with each other.

17. The children's vehicle according to claim 4, wherein there are two rear wheels disposed on the left and right sides of the bottom-rear portion of the main vehicle frame, and when the children's vehicle is in the unfolded state, a distance between the two front wheels in the left-right direction is greater than a distance between the two rear wheels.

18. The children's vehicle according to claim 17, wherein when the children's vehicle is in the folded state, the distance between the two front wheels in the left-right direction is equal to the distance between the two rear wheels.

19. The children's vehicle according to claim 4, wherein when the children's vehicle is switched from the unfolded state to the folded state, the front wheels move backward and are folded together with the main vehicle frame, and the joystick is folded between the two front wheels.

20. The children's vehicle according to claim 5, wherein the children's vehicle further comprises fifth connecting rods disposed between the main vehicle frame and the front wheels, one end portion of each of the fifth connecting rod is rotatably connected to the main vehicle frame and the other end thereof is rotatably connected to the respective front wheel, the fifth connecting rods and the first connecting rods are parallel to each other, and when the children's vehicle is in folding, the fifth connecting rods and the first connecting rods are folded close to the sides of the main vehicle frame together.
